(19) United States
(12) Patent Application Publication
(10) Pub. No.: US 2022/0264906 A1
(43) Pub. Date: Aug. 25, 2022

(54) SYSTEMS AND METHODS FOR STORING AND DISPENSING FOOD WITH CHAMBERS ADJOINED BY A HEAT TRANSFER COMPOUND

(71) Applicant: TAYLOR COMMERCIAL FOODSERVICE, LLC, Rockton, IL (US)

(72) Inventor: James I. MCCUTCHAN, Janesville, WI (US)

(21) Appl. No.: 17/622,970

(22) PCT Filed: Jun. 25, 2020
(86) PCT No.: PCT/US2020/039571

§ 371 Date: Dec. 27, 2021

Related U.S. Application Data
(60) Provisional application No. 62/868,150, filed on Jun. 28, 2019.

(51) Int. Cl. A23G 9/28; A23G 9/04

(52) U.S. Cl. CPC A23G 9/281; A23G 9/045; A23G 9/20

(57) ABSTRACT

A food dispensing system (1) including a graphite-based compound (6) that increases the heat transfer between a food storage compartment (3) and adjacent pipes (4), which may contain a propylene glycol fluid, for cooling the food product stored within the storage compartment (3). To assist with the production of a frozen food product, the system (1) may include a freezing chamber (16) adjoined via graphite-based compound (6) to pipes (23) adapted to freeze the food product. A heating chamber (26) may also be adjoined via graphite-based compound (6) to piping (28) adapted to heat the food product stored within the heating chamber (26). A controller (31) may adjust the temperature of the fluids within the pipes (4, 23, 28) to store the food products at desired temperatures.

### CROSS-REFERENCE TO RELATED APPLICATION

This application claims priority from U.S. Provisional Application No. 62/868,150, filed on Jun. 28, 2019, the entirety of which is hereby incorporated by reference herein.

### FIELD OF THE INVENTION

The present disclosure relates in general to the field of food dispensing machines, and in particular to methods and systems for storing food products in compartments at certain temperatures prior to dispensing the food products.

### BACKGROUND

Basic techniques and equipment for the storage and dispersal of food products are known in the art. While methods have been implemented to separately store and dispense food products, a systems and methods are desired to more efficiently control and centralize compartments for the storage of foods at various temperatures prior their dispersal through a machine by a consumer.

One drawback with certain implementations includes inefficient or absent heat transfer paths between the storage compartments and the sources that provide the necessary cooling or heating to ensure that the dispensed products are safe and desirable for consumption. For example, dispensing machines for frozen foods, such as soft serve ice cream, may have a refrigerated vat where the premixed ice cream product is stored before being drawn into the freezing cylinder. The vat is surrounded by copper piping, through which cold refrigerant flows. Normally, an ineffective heat transfer path between the copper pipe and the walls of the vat is established with solder. Only competent technicians with specialized welding training may be permitted to manufacture or prepare the storage chambers for food products. In addition to the high cost of labor, the materials and equipment for soldering metal components are expensive. Rather than maximizing the surface areas adjoined by soldering, insufficient amounts of solder are often applied due to the associated costs which results in ineffective heat transfer paths. Accordingly, financial concerns prohibit the production or enhancement of the systems that utilize metal alloys to establish operative heat transfer paths.

### BRIEF SUMMARY

The present disclosure may be embodied in various forms, including without limitation an apparatus, system or method for the improved storage of food products in chambers or compartments that require sufficient heat transfer paths to maintain various food products at certain temperatures prior to their dispersal. In accordance with certain embodiments, a graphite-based heat transfer compound may be utilized between the walls of a storage chamber and the adjacent pipes that are adapted to indirectly cool, freeze or heat the food products as desired. For example, in an embodiment, a food dispensing system may utilize a freezing chamber for ice cream or frozen yogurt and a heating chamber for hot fudge or melted caramel. The freezing chamber may be adjoined via a graphite-based compound to a pipe that contains a cold medium adapted to receive thermal energy from the system, and the heating chamber may be adjoined via a graphite-based compound to a second pipe that contains a hot medium adapted to provide thermal energy to the system. Due to the superior thermal conductivity of the graphite-based compound, the heat transfer between the chambers and corresponding pipes may be sufficient effective to ensure that the food products are maintained at certain temperatures based on the temperature of heat transfer medium in the adjoined piping.

In certain embodiments, the temperatures for the foods products may be efficiently controlled as a result of the thermal conductivity provided by the graphite-based compound. For example, the heat transfer capabilities of the graphite-based compound, the piping and the walls of the chambers may enable control of the temperatures of the food products via adjustments to the temperatures of the heat transfer medium within the piping. In some embodiments, a controller may be configured to operably adjust the predetermined temperature ranges for the heat transfer medium within the piping. The controller may be adapted to receive a temperature reading for the stored food product within the product storage chamber, a temperature reading for the frozen food product within the freezing chamber, a temperature reading for the second food product within the heating chamber, and temperature readings for the medium within the corresponding piping that are adjoined to the chambers.

### BRIEF DESCRIPTION OF THE DRAWINGS

The foregoing and other objects, features, and advantages for embodiments of the present disclosure will be apparent from the following more particular description of the embodiments as illustrated in the accompanying drawings, in which reference characters refer to the same parts throughout the various views. The drawings are not necessarily to scale, emphasis instead being placed upon illustrating principles of the present disclosure.

FIG. 1 is a photograph of an embodiment of a system for the storage of a food product within a vat adjoined to copper piping by a graphite-based heat transfer compound, in accordance with certain embodiments of the present disclosure.

FIG. 2 is a schematic diagram illustrating an embodiment of a food dispensing machine including a graphite-based compound applied between a food storage chamber and adjacent piping, in accordance with certain embodiments of the present disclosure.

FIG. 3 is a schematic diagram illustrating an embodiment of a food dispensing assembly adapted for the dispersal of a frozen food product from one dispensing nozzle and a hot or warm food product from a second dispensing nozzle, in accordance with certain embodiments of the present disclosure.

FIG. 4 is a flowchart illustrating an embodiment of a method for storing food within a product storage chamber, in accordance with certain embodiments of the present disclosure.

FIG. 5 is a diagram illustrating an embodiment of a system for the storage of a food product within a product storage chamber adjacent to piping that contains a heat transfer medium, in accordance with certain embodiments of the present disclosure.

FIG. 6 is a diagram illustrating the exemplary system illustrated in FIG. 5 showing the product storage chamber adjoined to the piping by a graphite-based heat transfer compound, in accordance with certain embodiments of the present disclosure.

### DETAILED DESCRIPTION OF EMBODIMENTS OF THE INVENTION

Reference will now be made in detail to the embodiments of the present disclosure, examples of which are illustrated in the accompanying drawings.

A benefit of the graphite-based heat transfer compound includes the inexpensive materials, equipment and labor needed to install the non-metallic compound relative to those used in soldering. Further, a graphite-based compound may readily flow within constricted cavities between chambers and piping. As a result, an advantage of the present disclosure may include the application of a graphite-based compound over greater surfaces of the storage chambers in order to increase the heat transfer path shared with adjacent piping. In turn, the increased size of the heat transfer path improves the amount of thermal energy that may be transferred between the storage chambers and the piping.

Another advantage of the graphite-based compound over solder includes the ability to apply the compound to an apparatus without the equipment and tools needed for soldering, and without the safety concerns associated with the handling of hot solder and a flame torch or a soldering iron. Most solder melt above 180° Celsius, or 356° Fahrenheit. In order to solder large areas, an iron may need to be heated above 400° Celsius or 752° Fahrenheit. Such high working temperatures may prohibit even a skilled welder from ensuring that the melted solder flows into constricted cavities in order to maximize the heat transfer path between a storage chamber and the convoluted piping wound around the chamber.

While a graphite-based compound may not be metallic, the covalent bonding for graphite permits a reliable connection with many metals. For example, graphite-based compounds may bond with steel, stainless steels, titanium, nickel, copper and aluminum alloys. In some embodiments, the bonding capability of a graphite-based compound may include the ability to secure a firm connection between a storage chamber and adjacent piping.

A further benefit of graphite-based compounds include their superior thermal conductivity. At room temperature, around 20° Celsius or 68° Fahrenheit, the thermal conductivity (symbolized by k) of natural graphite may reach 470 Watts per meter per Kelvin (denoted as W/mK), which may be as high as that of the best metals. For example, at room temperature, the thermal conductivity for pure copper may be around 400 W/mK. In contrast, the thermal conductivity for many solders (e.g., alloys comprising 63% of tin and 37% of lead) may be only around 50 W/mK.

The increased heat transfer enabled by the thermal conductivity of graphite-based compounds may provide for greater control over the desired temperatures for the food products contained within the storage compartments. The thermal conductivity of graphite-based compound may match the thermal conductivity of copper-based housing, which may be used to construct both a storage compartment and the adjacent piping. In some embodiments, the heightened and consistent thermal conductivity for the heat transfer between the medium within the piping and the food product within the storage chambers may further enable control of the temperatures of the food products via adjustments to the temperatures of the heat transfer medium within the piping. As an additional benefit appreciated by certain embodiments, such control may ensure that the dispensed food products have a desired temperature so that they are safe for consumption and appropriately frozen or melted in order to meet the expectation and satisfaction of consumers.

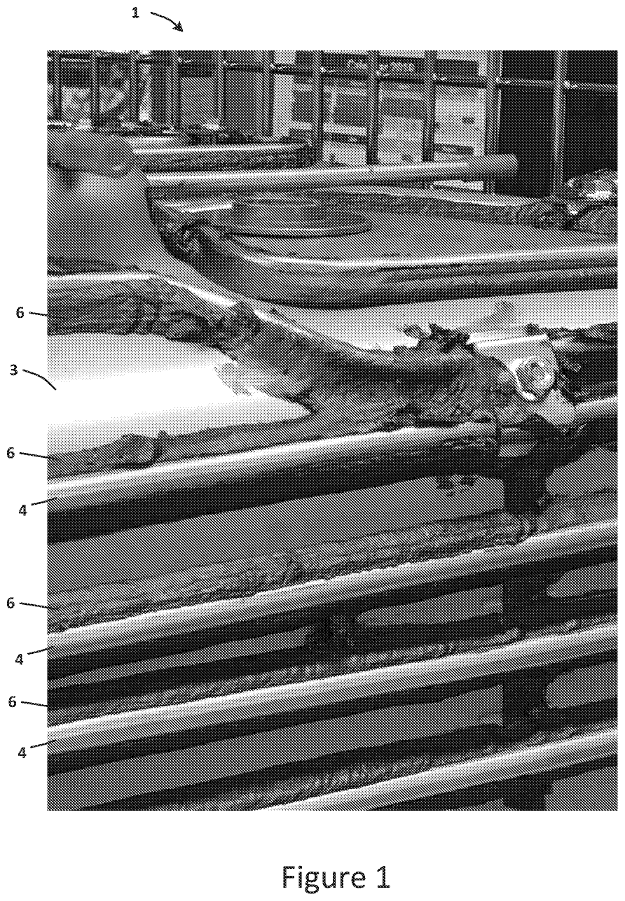

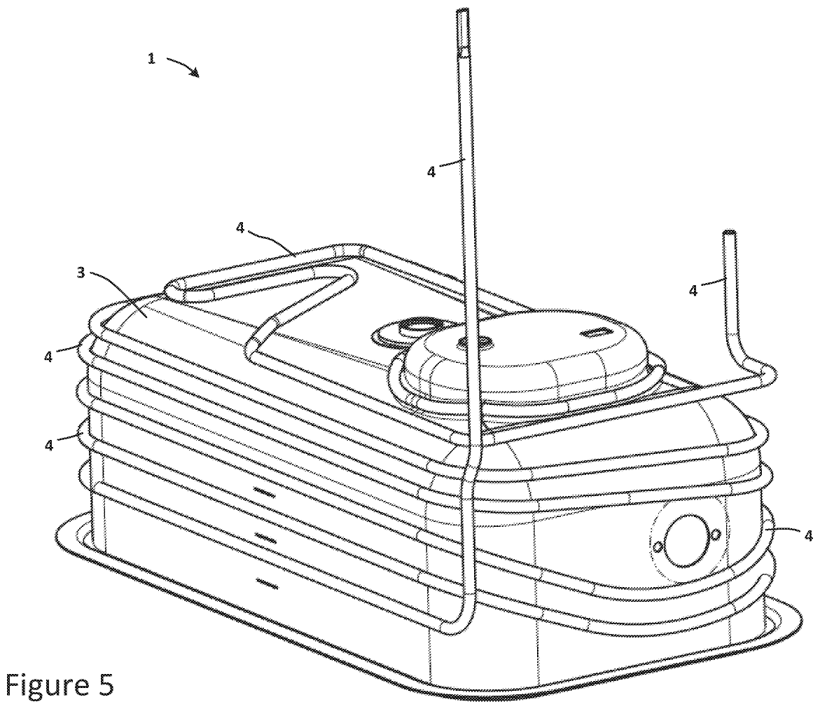

In accordance with certain embodiments, FIGS. 1 and 5 shows a system or machine 1 for the storage of a food product 2 (not shown) within a product storage compartment or chamber 3 (e.g., a vat) adjacent to pipes 4, which contain a heat transfer medium 5 (not shown) such as a heat transfer liquid 5 and/or a heat transfer gas 5. The storage chamber 3 and the pipes 4 may be adjoined by a graphite-based heat transfer compound 6. The product storage chamber 3 may be adapted to receive thermal energy from the stored food product 2. The system 1 depicted in FIGS. 1 and 5 includes a storage chamber 3 that may be placed within a machine that dispenses the stored food product 2 directly to a consumer. In an embodiment, the system 1 may include an industrial-sized storage chamber 3 (e.g., a large vat) that may be located within a food production facility which generates large amounts of food product 2 that may be packaged and distributed to retailers and the consuming public.

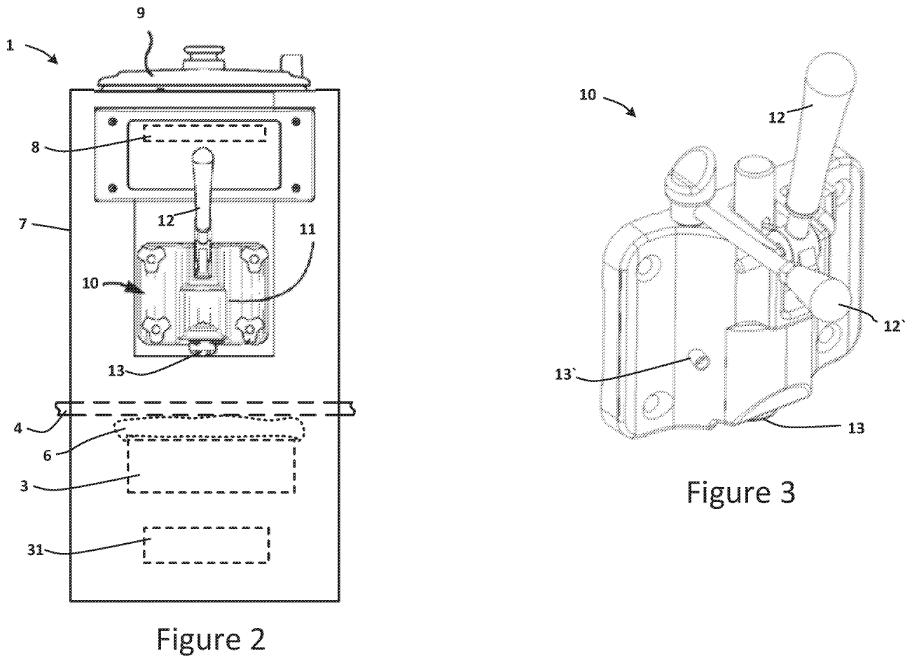

In certain embodiments, the storage chamber 3 may comprise a hopper 3 located within the housing of a food dispensing machine or system 1. To provide additional context of the technical field and the food dispensing machine 1 disclosed herein, the U.S. Pat. No. 9,848,620, which issued on Dec. 26, 2017 and described a frozen food dispensing machine, is hereby incorporated by reference in its entirety. As illustrated by the embodiment in FIG. 2, within the food dispensing machine or system 1, a pipe 4 may be adjoined by a graphite-based heat transfer compound 6. The pipe 4 may contain a heat transfer medium 5 (not shown), which may have a predetermined temperature in order to indirectly cool or heat the food product 2 (not shown) contained within the storage chamber 3 via a transfer of thermal energy through the wall of the pipe 2, the graphite-based compound 6, and the wall of the chamber 3. The pipe 4 may enter one side of the food dispensing machine 1, and exist another side of the food dispensing machine 1.

FIG. 2 further shows a housing 7 for the food dispensing machine 1, in accordance with some embodiments. The top of the housing 7 may include an opening adapted to receive a confection or its ingredients, which may be stirred and beaten by a mixing hopper 8. The opening may be covered by a lid 9. The front of the food dispensing machine 1 may include a dispenser or dispensing assembly 10, having a front surface 11 with a lever 12 adapted to actuate the dispersal of a food product 2 from the machine 1 via a dispensing nozzle 13. In an embodiment, a user of the dispensing machine 1 may pull a lever 12 or push a button (not shown) in order to receive food or beverage product(s) 2 from the machine 1.

FIG. 3 illustrates a dispensing assembly 10 having two levers 12 and 12′, and two corresponding dispensing nozzles 13 and 13′, that facilitate the dispersal of two food products 2. In some embodiments, a food product 2 may comprise a beverage 2 or a food 2 that may be cooled prior to existing the dispensing machine 1. In an embodiment, the machine 1 may comprise a carbonated beverage machine that may introduce a mixture of water, syrup and carbon dioxide gas to dispense a food product 2 such as a carbonated beverage 2. In certain embodiments, the dispensing machine 1 may store and dispense different types of food product 2 at different temperatures. For example, a machine 1 may dispense a frozen food 2, such as soft serve ice cream or frozen yogurt, and a second food product 2, such as a topping for the frozen food 2 (e.g., hot fudge or melted caramel). The two food products 2 may be stored at different temperatures in separate chambers located within the dispensing machine 1. In an embodiment, the machine 1 may store and dispense a beverage 2 and a frozen beverage 2 that are mixed using the same flavored syrup, stored at different temperatures in two separate chambers, and dispensed via two separate dispensing nozzles. In certain embodiments, the food products 2 may be stored in auxiliary reservoirs 3, which may be operably connected to the dispensing machine 1 via conduits that supply the food products 2. Depending upon the particular implementation, the storage chamber 3 may be substantially remote of the dispensing machine 1 (such as in a service room) with the machine 1 being located behind the counter in a restaurant or along a buffet line or the like.

In an embodiment, a cooling pipe 4 may be adapted to indirectly receive thermal energy from the product storage chamber 3. The product storage chamber 3 may be adapted to indirectly transfer thermal energy from the stored food product 2 to the cooling pipe 4. The cooling pipe 4 may be configured to contain a heat transfer medium 14 (not shown). In an embodiment, the medium 14 may flow through the pipe 4. The heat transfer medium 14 may be adapted to receive thermal energy from an interior surface 15 of the cooling pipe 4. In certain embodiments, the heat transfer medium 14 may comprise a propylene glycol fluid, a propylene glycerin fluid, a refrigerant or water. The heat transfer medium 14 may comprise various forms or phases, such as a liquid, a gas, any mix thereof or any intermediate state between a liquid-state and a gaseous state. The cooling pipe 4 and the storage chamber 3 may be made of metal. In an embodiment, this metal may comprise a copper alloy.

In certain embodiments, the food dispensing system 1 may further include a freezing chamber 16 that may be operably connected to the product storage chamber 3. The freezing chamber 16 may be configured to receive the stored food product 2 from the product storage chamber 3. The freezing chamber 16 may be adapted to receive thermal energy from the received food product 2′ (not shown). In some embodiments, the freezing chamber 16 may be configured to freeze the received food product 2′. In an embodiment, the freezing chamber 16 may comprise a heat exchanger or an evaporator.

A frozen food dispenser 10 may be operably connected to the freezing chamber 16, in accordance with certain embodiments. In an embodiment, the frozen food dispenser 10 may be configured to receive the frozen food product 2″ (not shown) from the freezing chamber 16. The frozen food dispenser 10 may be configured to dispense the frozen food product 2″.

A heat transfer compound 6 may adjoin or boarder an exterior surface 17 of the product storage chamber 3 and an exterior surface 18 of the cooling pipe 4. In some embodiments, wherein the cooling pipe 4 is positioned above the product storage chamber 3, the heat transfer compound 6 may abut a top surface 17 of the product storage chamber 3 and a bottom surface 18 of the cooling pipe 4. The bottom surface 18 may traverse a longitude axis 19 of the cooling pipe 4. In certain embodiment, the heat transfer compound 6 may partially fill a cavity 20. The cavity 20 may be partially defined by an exterior surface 18 of the cooling pipe 4 and an exterior surface 17 of the product storage chamber 3.

The heat transfer compound 6 may be adapted to directly transfer thermal energy from the product storage chamber 3 to the cooling pipe 4. The stored food product 2 within the product storage chamber 3 may have a stored temperature 21 based on the heat exchange between the stored food product 2 and the heat transfer medium 14 within the cooling pipe 4. In some embodiments, the heat transfer medium 14 may have a predetermined temperature range 22. The stored food product 2 within the product storage chamber 3 may have a stored temperature 21 based on the predetermined temperature range 22 of the medium 14 within the cooling pipe 4.

The heat transfer compound 6 may comprise graphite. In an embodiment, the heat transfer compound 6 may comprise thirty (30) to sixty (60) weight percent of graphite. The graphite-based heat transfer compound 6 may be water-soluble. In some embodiments, the heat transfer compound 6 may comprise a mixture of graphite, sodium silicate and clay. In certain embodiments, the heat transfer compound 6 may consist essentially of graphite, sodium silicate and clay. In an embodiment, the heat transfer compound 6 may comprise at least thirty (30) weight percent of graphite, at least thirty (30) weight percent of sodium silicate, and at least one (1) weight percent of clay. A heat transfer compound 6 may comprise thirty (30) to sixty (60) weight percent of sodium silicate. A heat transfer compound 6 may comprise one (1) to twenty (20) weight percent of clay.

In accordance with certain embodiments, the food dispensing machine 1 may further comprise a freezing pipe 23 adapted to indirectly receive thermal energy from the freezing chamber 16. The freezing chamber 16 may be adapted to indirectly transfer thermal energy from the received food product 2′ within the freezing chamber 16 to the freezing pipe 23. The freezing pipe 23 may be configured to contain a second heat transfer medium 24. The second heat transfer medium 24 may be adapted to receive thermal energy from an interior surface 25 of the freezing pipe 23. A second heat transfer compound 6′ may abut or adjoin the freezing chamber 16 and the freezing pipe 23. The second heat transfer compound 6′ may be adapted to directly transfer thermal energy from the freezing chamber 16 to the freezing pipe 23. The second heat transfer compound 6′ may comprise graphite. In an embodiment, the second heat transfer compound 6′ may comprise: thirty (30) to sixty (60) weight percent of graphite, thirty (30) to sixty (60) weight percent of sodium silicate, and one (1) to twenty (20) weight percent of clay.

In certain embodiments, the food dispensing machine 1 may further comprise a heating chamber 26 configured to store a second food product 27, which may be a warm or hot food 27. The heating chamber 26 may be operably connected to a food dispenser or dispensing assembly 10 adapted for warm food products 27. In an embodiment, the heating chamber 26 may be operably connected to the dispensing nozzle 13′ illustrated in FIG. 3. The warm food dispensing nozzle 13′ may be adjacent to the frozen food dispensing nozzle 13, projecting out of the same dispensing assembly 10. The warm food dispenser 10 may be configured to serve the second food product 27 stored within the heating chamber 26. A heating pipe 28 may be adapted to indirectly transfer thermal energy to the heating chamber 26. The heating chamber 26 may be adapted to indirectly transfer thermal energy from the heating pipe 28 to the second food product 27 within the heating chamber 26. The heating pipe 28 may be configured to contain a third heat transfer medium 29. An interior surface 30 of the heating pipe 28 may be adapted to receive thermal energy from the third heat transfer medium 29. A third heat transfer compound 6″ may abut or adjoin the heating chamber 26 and the heating pipe 28. The third heat transfer compound 6″ may be adapted to directly transfer thermal energy from the heating pipe 28 to the heating chamber 26. The third heat transfer compound 6″ may comprise graphite. In an embodiment, the third heat transfer compound 6″ may comprise: thirty (30) to sixty (60) weight percent of graphite, thirty (30) to sixty (60) weight percent of sodium silicate, and one (1) to twenty (20) weight percent of clay.

In some embodiments, the heat transfer compounds 6, 6′ and 6″ may comprise the same components, e.g. graphite, sodium silicate and clay. In certain embodiments, the heat transfer compounds 6, 6′ and 6″ may comprise: thirty (30) to sixty (60) weight percent of graphite, thirty (30) to fifty (50) weight percent of sodium silicate, and ten (10) to twenty (20) weight percent of clay (e.g., ball clay). In certain embodiments, the heat transfer compounds 6, 6′ and 6″ may comprise: thirty (30) to sixty (60) weight percent of graphite, thirty (30) to sixty (60) weight percent of sodium silicate, and one (1) to five (5) weight percent of clay (e.g., ball clay). The components of the heat transfer compounds 6, 6′ and 6″ may be chemically bonded. In an embodiment, the heat transfer mediums 5, 14, 24 and 29 may comprise the same substance or mixture. These mediums 5, 14, 24 and 29 may comprise water, a refrigerant, a propylene glycerin fluid, a propylene glycol fluid or an ethylene glycol fluid, such as the glycol-based heat transfer fluid known as Dowtherm SR-1 that is readily available from the Dow Chemical Company. In certain embodiments, the pipes 4, 23, 28 and the food chambers 3, 16 and 26 may be made of the same material, e.g. a copper alloy. The compounds, mediums and materials may be selected to ensure superior thermal conductivity and reliable heat transfer paths.

In embodiment, the heat transfer compounds 6, 6′ and 6″ may each comprise a flowable mixture adapted to be cured into corresponding solid compounds 6, 6′ and 6″. The first solid compound 6 may be adapted to transfer thermal energy from the product storage chamber 3 to the cooling pipe 4. The second solid compound 6′ may be adapted to transfer thermal energy from the freezing chamber 16 to the freezing pipe 23. The third solid compound 6″ may be adapted to transfer thermal energy from the heating pipe 28 to the heating chamber 26. In some embodiments, the heat transfer compounds 6, 6′ and 6″ may be adapted to be cured by air-drying at room temperature within 24 hours. The heat transfer compounds 6, 6′ and 6″ may each comprise a solid or semi-solid compound 6, 6′ and 6″ produced by curing a flowable mixture. The flowable mixture may comprising graphite. The heat transfer compounds 6, 6′ and 6″ may comprise a foam.

In certain embodiments, the food chambers 3, 16 and 26 may be thermally isolated from one another. The pipes 4, 23, 28 may also be thermally isolated from one another. Further, the frozen food dispensing nozzle 13 and the warm food dispensing nozzle 13′ may be thermally isolated from one another. The nozzles 13 and 13′ may be made of a thermally insulating material. In an embodiment, a thermally insulating material may be placed between each of the pipes 4, 23, 28 and each of the food chambers 3, 16 and 26. A thermal insulator 40 (not shown) may be positioned between each of the pipes 4, 23, 28 and between each of the food chambers 3, 16 and 26 in order to inhibit the undesired transfer of thermal energy. In certain embodiments, the thermal isolation between components (i.e., the chambers, pipes and nozzles) may be achieved by physically separating the components so that an air gap sufficiently inhibits the undesired transfer of thermal energy.

In some embodiments, each of the heat transfer mediums 5, 14, 24 and 29 may have a predetermined temperature range 22. In certain embodiments, the food dispensing system 1 may include a controller 31 configured to operably adjust the predetermined temperature ranges 22 for the heat transfer mediums 5, 14, 24 and 29. The predetermined temperature ranges 22 may be received via a user interface 41. The controller 31 may be adapted to receive a temperature reading 32 for the stored food product 2 within the product storage chamber 3, a temperature reading 32 for the frozen food product 2″ within the freezing chamber 16, a temperature reading 32 for the second food product 27 within the heating chamber 26, and temperature readings 32 for the heat transfer mediums 5, 14, 24 and 29. Referring back to FIG. 2, the controller 31 may be located within the food dispensing system 1.

The circuitry for the controller 31 may include hardware, software, middleware, application program interfaces (APIs), and/or other components for implementing the corresponding features of the circuitry. In an embodiment, the circuitry may include a computer device on which the features of the system 1 may be executed. The computer device may include communication interfaces, system circuitry, input/output (I/O) interface circuitry, and display circuitry. The graphical user interfaces (GUIs) displayed by the display circuitry may be representative of GUIs generated by the system 1 to present a query to an enterprise application or end user, requesting temperature information. The graphical user interfaces (GUIs) displayed by the display circuitry may also be representative of GUIs generated by the system 1 to receive query inputs identifying the predetermined temperature ranges 22. The GUIs may be displayed locally using the display circuitry, or for remote visualization, e.g., as HTML, JavaScript, audio, and video output for a web browser running on a local or remote machine. Among other interface features, the GUIs may further render displays of any alerts resulting from the monitored temperatures, e.g. temperature readings 32.

The GUIs and the I/O interface circuitry may include touch sensitive displays, voice or facial recognition inputs, buttons, switches, speakers and other user interface elements. Additional examples of the I/O interface circuitry includes microphones, video and still image cameras, headset and microphone input/output jacks, Universal Serial Bus (USB) connectors, memory card slots, and other types of inputs. The I/O interface circuitry may further include magnetic or optical media interfaces (e.g., a CDROM or DVD drive), serial and parallel bus interfaces, and keyboard and mouse interfaces. The communication interfaces may include wireless transmitters and receivers (“transceivers”) and any antennas used by the transmit-and-receive circuitry of the transceivers. The transceivers and antennas may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces may also include serial interfaces, such as universal serial bus (USB), serial ATA, IEEE 1394, lighting port, I²C, slimBus, or other serial interfaces. The communication interfaces may also include wireline transceivers to support wired communication protocols. The wireline transceivers may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol.

The system circuitry may be implemented, for example, with one or more systems on a chip (SoC), application specific integrated circuits (ASIC), microprocessors, discrete analog and digital circuits, and other circuitry. The system circuitry may implement any desired functionality of the system 1. As just one example, the system circuitry may include one or more instruction processor and memory. The memory stores, for example, control instructions for executing the features of the system 1, as well as an operating system. In one implementation, the processor executes the control instructions and the operating system to carry out any desired functionality for the system 1. Control parameters may provide and specify configuration and operating options for the predetermined temperature ranges 22. The graphical user interfaces (GUIs) 41 for the controller 31 may be located on the housing 7 for the food dispensing machine 1.

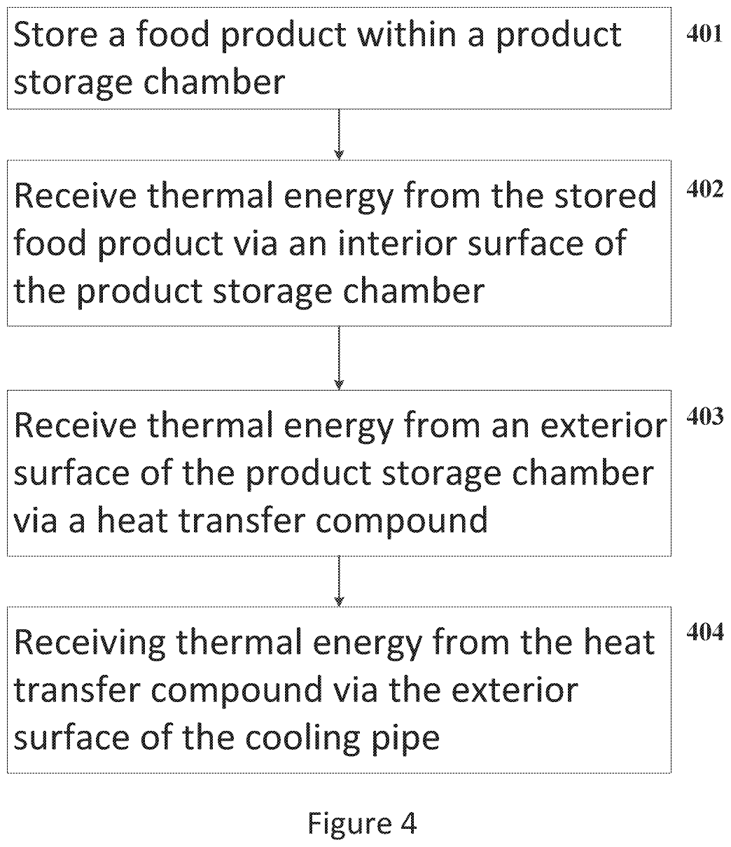

In an embodiment of the present disclosure, as set forth in block 401 of FIG. 4, a method for storing food 2 within a food storage machine 1 may include the step of storing a food product 2 within a product storage chamber 3. In some embodiments, the product storage chamber 3 may be operably connected to a freezing chamber 16 and a frozen food dispenser 10. The freezing chamber 16 may be configured to receive the stored food product 2 from the product storage chamber 3. The freezing chamber 16 may be configured to freeze the received food product 2′. The frozen food dispenser 10 may be configured to receive the frozen food product 2″ from the freezing chamber 16. The frozen food dispenser 10 may be further configured to dispense the frozen food product 2″. The method may also include the step of receiving thermal energy from the stored food product 2 via an interior surface 33 of the product storage chamber 3 (block 402).

The food storage method may include the step of receiving thermal energy from an exterior surface 17 of the product storage chamber 3 via a heat transfer compound 6 (block 403). The heat transfer compound 6 may abut or boarder the exterior surface 17 of the product storage chamber 3 and an exterior surface 18 of a cooling pipe 4. The heat transfer compound 6 may comprise graphite. The method may also include the step of receiving thermal energy from the heat transfer compound 6 via the exterior surface 18 of the cooling pipe 4. The cooling pipe 4 may be configured to contain a heat transfer medium 14. The heat transfer medium 14 may be adapted to receive thermal energy from an interior surface 15 of the cooling pipe 4. The heat transfer medium 14 may have a temperature within a predetermined temperature range 22. The stored food product 2 within the product storage chamber 3 may have a stored temperature 21 based on the predetermined temperature range 22.

In accordance with some embodiments, the method for the construction, manufacture or preparation of a food dispensing machine 1 may include the step of positioning a cooling pipe 4 adjacent to a product storage chamber 3. An exterior surface 18 of the cooling pipe 4 and an exterior surface 17 of the product storage chamber 3 may define a first cavity 20. The product storage chamber 3 may be configured to store a food product 2. The product storage chamber 3 may be adapted to indirectly transfer thermal energy from the stored food product 2 to the cooling pipe 4.

The method may further include the step of filling, at least partially, the first cavity 20 with a first heat transfer compound 6. The first heat transfer compound 6 may abut or adjoin the exterior surface 18 of the cooling pipe 4 and the exterior surface 17 of the product storage chamber 3. The first heat transfer compound 6 may be adapted to directly transfer thermal energy from the product storage chamber 3 to the cooling pipe 4. The first heat transfer compound 3 may comprise graphite. The method may include the step of filling the cooling pipe 4 with a first heat transfer medium 14. The first heat transfer medium 14 may be adapted to receive thermal energy from an interior surface 15 of the cooling pipe 4. Further, the method may include the step of filling the product storage chamber 3 with the food product 2. The product storage chamber 3 may be operably connected to a freezing chamber 16 and a frozen food dispenser 10. The freezing chamber 16 may be configured to receive the stored food product 2 from the product storage chamber 3. The freezing chamber 16 may be adapted to receive thermal energy from the received food product 2′. The freezing chamber 16 may be configured to freeze the received food product 2′. The frozen food dispenser 10 may be configured to receive the frozen food product 2″ from the freezing chamber 16. The frozen food dispenser 10 may be configured to dispense the frozen food product 2″.

In some embodiments, the preparation method may further include the step of positioning a freezing pipe 23 adjacent to the freezing chamber 16. An exterior surface 34 of the freezing pipe 23 and an exterior surface 35 of the freezing chamber 16 may define a second cavity 36. The freezing chamber 16 may be adapted to indirectly transfer thermal energy from the received food product 2′ within the freezing chamber 16 to the freezing pipe 23. The method may also include the step of filling, at least partially, the second cavity 36 with a second heat transfer compound 6′. The second heat transfer compound 6′ may abut or adjoin the exterior surface 34 of the freezing pipe 23 and the exterior surface 35 of the freezing chamber 16. The second heat transfer compound 6′ may be adapted to directly transfer thermal energy from the freezing chamber 16 to the freezing pipe 23. The method may include the step of filling the freezing pipe 23 with a second heat transfer medium 24. The medium 24 may be adapted to receive thermal energy from an interior surface 25 of the freezing pipe 23.

In certain embodiments, the preparation method may further include the step of positioning a heating pipe 28 adjacent to a heating chamber 26. The heating chamber 26 may be operably connected to a warm food dispenser 10. The warm food dispenser 10 may be adjacent to the frozen food dispenser 10. The warm food dispenser 10 may be configured to dispense a second food product 27 stored within the heating chamber 26. The heating chamber 26 may be adapted to transfer thermal energy from the heating pipe 28 to the second food product 27 contained within the heating chamber 26. An exterior surface 37 of the heating pipe 28 and an exterior surface 38 of the heating chamber 26 may define a third cavity 39. The method may include the step of filling, at least partially, the third cavity 39 with a third heat transfer compound 6″. The third heat transfer compound 6″ may abut or adjoin the exterior surface 37 of the heating pipe 28 and the exterior surface 38 of the heating chamber 26. The third heat transfer compound 6″ may be adapted to transfer thermal energy from the heating chamber 26 to the heating pipe 28. The method may include the step of filling the heating pipe 28 with a third heat transfer medium 29. An interior surface 30 of the heating pipe 28 may be adapted to receive thermal energy from the third heat transfer medium 29.

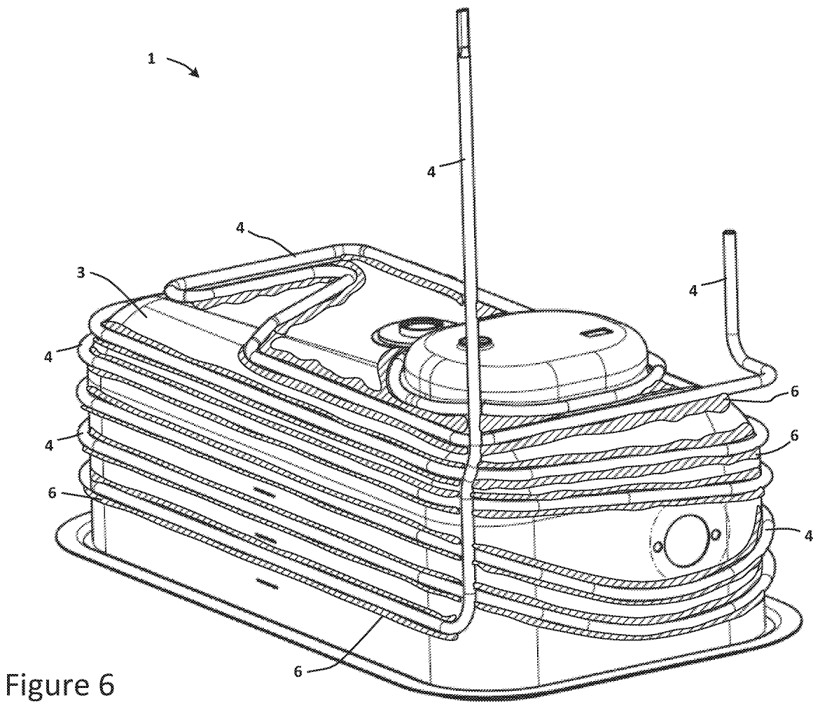

Referring to FIGS. 5 and 6, an embodiment of the disclosed system 1 may include a storage chamber 3 (e.g., a vat) surrounded by pipes 4 that may contain a heat transfer medium 5 (not shown). As shown in FIG. 6, the storage chamber 3 may be adjoined to the pipes 4 by inserting a graphite-based heat transfer compound 6 within gaps or cavities 20 between the storage chamber 3 and the pipes 4. The graphite-based heat transfer compound 6 may be applied along the exterior surface 18 of the pipes 4 and the exterior surface 17 of the product storage chamber 3. In some embodiments, the pipes 4 may be adapted to cool the food product 2 within the product storage chamber 3 at a stored temperature 21 based on a predetermined temperature range 22 of the heat transfer medium 14. The stored temperature 21 may be between 32° Fahrenheit (0° Celsius) and 65° Fahrenheit (18.3° Celsius). In an embodiment, the pipes 4 shown FIGS. 5 and 6 may comprising freezing pipes 23 adapted to freeze the food product 2, and the chamber 3 shown FIGS. 5 and 6 may compromise a freezing chamber 16 configured to freeze the food product at stored temperature 21 less than 32° Fahrenheit (0° Celsius).

In an embodiment, the food storage machine 1 may store a frozen food product 42. The machine 1 may include a freezing chamber 16 configured to store the frozen food product 42. The freezing chamber 16 may be adapted to receive thermal energy from the stored frozen food product 42. A freezing pipe 23 may be adapted to indirectly receive thermal energy from the freezing chamber 16. The freezing chamber 16 may be adapted to indirectly transfer thermal energy from the stored food product 42 to the freezing pipe 23. The freezing pipe 23 may be configured to contain a heat transfer medium 24. The heat transfer medium 24 may be adapted to receive thermal energy from an interior surface 25 of the freezing pipe 23. A heat transfer compound 6 may adjoin or abut the freezing chamber 16 and the freezing pipe 23. The heat transfer compound 6 may be adapted to directly transfer thermal energy from the freezing chamber 16 to the freezing pipe 23. The heat transfer compound 6 may comprise graphite.

The food storage machine 1 may store a warm or heated food product 27, in accordance with certain embodiments. The machine 1 may include a heating pipe 28 configured to contain a heat transfer medium 29. An interior surface 30 of the heating pipe 28 may be adapted to receive thermal energy from the heat transfer medium 29. A heating chamber 26 may be configured to store a heated food product 27. The heating chamber 26 may be adapted to indirectly receive thermal energy from the heating pipe 28. The heating chamber 26 may be adapted to indirectly transfer thermal energy from the heating pipe 28 to the stored, heated food product 27 within the heating chamber 26. A heat transfer compound 6 may adjoin or abut the heating chamber 26 and the heating pipe 28. The heat transfer compound 6 may be adapted to directly transfer thermal energy from the heating pipe 28 to the heating chamber 26. The heat transfer compound 6 may comprise graphite.

While the present disclosure has been particularly shown and described with reference to an embodiment thereof, it will be understood by those skilled in the art that various changes in form and details may be made therein without departing from the spirit and scope of the present disclosure. Although some of the drawings illustrate a number of operations in a particular order, operations that are not order-dependent may be reordered and other operations may be combined or broken out. While some reordering or other groupings are specifically mentioned, others will be apparent to those of ordinary skill in the art and so do not present an exhaustive list of alternatives.

1. A machine for storing a frozen food product, comprising:
a freezing chamber configured to store a food product, the freezing chamber adapted to receive thermal energy from the stored food product;
a freezing pipe adapted to indirectly receive thermal energy from the freezing chamber, the freezing chamber adapted to indirectly transfer thermal energy from the stored food product to the freezing pipe, the freezing pipe configured to contain a heat transfer medium, the heat transfer medium adapted to receive thermal energy from an interior surface of the freezing pipe; and,
a heat transfer compound abutting the freezing chamber and the freezing pipe, the heat transfer compound adapted to directly transfer thermal energy from the freezing chamber to the freezing pipe, the heat transfer compound comprising graphite.

2. (canceled)

3. A machine, comprising:
a product storage chamber configured to store a food product, the product storage chamber adapted to receive thermal energy from the stored food product;
a cooling pipe adapted to indirectly receive thermal energy from the product storage chamber, the product storage chamber adapted to indirectly transfer thermal energy from the stored food product to the cooling pipe, the cooling pipe configured to contain a first heat transfer medium, the first heat transfer medium adapted to receive thermal energy from an interior surface of the cooling pipe; and,
a first heat transfer compound abutting the product storage chamber and the cooling pipe, the first heat transfer compound adapted to directly transfer thermal energy from the product storage chamber to the cooling pipe, the first heat transfer compound comprising graphite.

4. The machine of claim 3, wherein the first heat transfer compound comprises 30 to 60 weight percent of graphite.

5. The machine of claim 3, wherein the first heat transfer compound comprises a mixture of graphite, sodium silicate and clay.

6. The machine of claim 3, wherein the first heat transfer compound consists essentially of graphite, sodium silicate and clay.

7. The machine of claim 3, wherein the first heat transfer compound comprises at least 30 weight percent of graphite, at least 30 weight percent of sodium silicate, and at least 1 weight percent of clay.

8. The machine of claim 3, wherein the first heat transfer compound is adapted to be cured by air-drying at room temperature within 24 hours.

9. The machine of claim 3, wherein the first heat transfer compound comprises a flowable mixture adapted to be cured into a solid compound, the solid compound adapted to transfer thermal energy from the product storage chamber to the cooling pipe.

10. The machine of claim 3, wherein the first heat transfer compound comprises a semi-solid compound.

11. The machine of claim 3, wherein the first heat transfer medium is selected from a group consisting of: a refrigerant, a propylene glycol fluid, and a propylene glycerin fluid.

12. The machine of claim 3, further comprising:
a controller configured to operably adjust a predetermined temperature range for the first heat transfer medium, wherein the controller is adapted to receive a temperature reading for the stored food product within the product storage chamber, and a temperature reading for the first heat transfer medium.

13. The machine of claim 3, further comprising:
a food dispenser operably connected to the product storage chamber, the food dispenser configured to receive the food product from the product storage chamber, the food dispenser configured to dispense the food product.

14. The machine of claim 3, further comprising:
a freezing chamber operably connected to the product storage chamber, the freezing chamber configured to receive the stored food product from the product storage chamber, the freezing chamber adapted to receive thermal energy from the received food product, the freezing chamber configured to freeze the received food product;
a freezing pipe adapted to indirectly receive thermal energy from the freezing chamber, the freezing chamber adapted to indirectly transfer thermal energy from the received food product within the freezing chamber to the freezing pipe, the freezing pipe configured to contain a second heat transfer medium, the second heat transfer medium adapted to receive thermal energy from an interior surface of the freezing pipe; and,
a second heat transfer compound abutting the freezing chamber and the freezing pipe, the second heat transfer compound adapted to directly transfer thermal energy from the freezing chamber to the freezing pipe, the second heat transfer compound comprising graphite.

15. The machine of claim 14, further comprising:
a frozen food dispenser operably connected to the freezing chamber, the frozen food dispenser configured to receive the frozen food product from the freezing chamber, the frozen food dispenser configured to dispense the frozen food product.

16. The machine of claim 15, further comprising:
a beverage dispenser operably connected to the product storage chamber, the stored food product comprising a beverage, the beverage dispenser configured to receive the beverage from the product storage chamber, the beverage dispenser configured to dispense the beverage.

17. The machine of claim 15, further comprising:
a heating chamber configured to store a second food product, the heating chamber operably connected to a warm food dispenser, the warm food dispenser adjacent to the frozen food dispenser, the warm food dispenser configured to dispense the second food product stored within the heating chamber;
a heating pipe adapted to indirectly transfer thermal energy to the heating chamber, the heating chamber adapted to indirectly transfer thermal energy from the heating pipe to the second food product within the heating chamber, the heating pipe configured to contain a third heat transfer medium, an interior surface of the heating pipe adapted to receive thermal energy from the third heat transfer medium; and,
a third heat transfer compound abutting the heating chamber and the heating pipe, the third heat transfer compound adapted to directly transfer thermal energy from the heating pipe to the heating chamber, the third heat transfer compound comprising graphite.

18. The machine of claim 17, wherein the food product is selected from a group consisting of ice cream and frozen yogurt, wherein the second food product is a topping for the food product, and wherein the topping selected from a group consisting of hot fudge and caramel.

19. The machine of claim 17, wherein the product storage chamber, the freezing chamber, and the heating chamber are thermally isolated from one another by placement of insulators between each chamber; wherein the cooling pipe, the freezing pipe, and the heating pipe are thermally isolated from one another by placement of the insulators between each pipe; wherein the frozen food dispenser and the warm food dispenser are thermally isolated from one another; and wherein the insulators inhibit the transfer of thermal energy.

20-21. (canceled)

22. A method for preparation of a food storage machine, comprising:
positioning a cooling pipe adjacent to a product storage chamber, wherein an exterior surface of the cooling pipe and an exterior surface of the product storage chamber define a first cavity, wherein the product storage chamber is configured to store a food product, and wherein the product storage chamber is adapted to indirectly transfer thermal energy from the stored food product to the cooling pipe;
at least partially filling the first cavity with a first heat transfer compound, wherein the first heat transfer compound abuts the exterior surface of the cooling pipe and the exterior surface of the product storage chamber, wherein the first heat transfer compound is adapted to directly transfer thermal energy from the product storage chamber to the cooling pipe, and wherein the first heat transfer compound comprises graphite;
filling the cooling pipe with a first heat transfer medium, wherein the first heat transfer medium is adapted to receive thermal energy from an interior surface of the cooling pipe; and,
filling the product storage chamber with the food product.

23. The method of claim 22, further comprising the steps of:
positioning a freezing pipe adjacent to a freezing chamber, wherein the freezing chamber is operably connected to the product storage chamber, wherein the freezing chamber is configured to receive the stored food product from the product storage chamber, wherein the freezing chamber adapted to receive thermal energy from the received food product, wherein the freezing chamber is configured to freeze the received food product, wherein an exterior surface of the freezing pipe and an exterior surface of the freezing chamber define a second cavity, wherein the freezing chamber is adapted to indirectly transfer thermal energy from the received food product within the freezing chamber to the freezing pipe;
at least partially filling the second cavity with a second heat transfer compound, wherein the second heat transfer compound abuts the exterior surface of the freezing pipe and the exterior surface of the freezing chamber, wherein the second heat transfer compound is adapted to directly transfer thermal energy from the freezing chamber to the freezing pipe, and wherein the second heat transfer compound comprises graphite; and,
filling the freezing pipe with a second heat transfer medium, wherein the second heat transfer medium is adapted to receive thermal energy from an interior surface of the freezing pipe.

24. The method of claim 23, further comprising the steps of:
positioning a heating pipe adjacent to a heating chamber, wherein the heating chamber is operably connected to a warm food dispenser, wherein the warm food dispenser is configured to dispense a second food product stored within the heating chamber, wherein the warm food dispenser is adjacent to a frozen food dispenser operably connected to the freezing chamber, wherein the frozen food dispenser is configured to receive the frozen food product from the freezing chamber, wherein the frozen food dispenser is configured to dispense the frozen food product, wherein the heating chamber is adapted to transfer thermal energy from the heating pipe to the second food product contained within the heating chamber, wherein an exterior surface of the heating pipe and an exterior surface of the heating chamber define a third cavity;
at least partially filling the third cavity with a third heat transfer compound, wherein the third heat transfer compound abuts the exterior surface of the heating pipe and the exterior surface of the heating chamber, wherein the third heat transfer compound is adapted to transfer thermal energy from the heating chamber to the heating pipe, and wherein the third heat transfer compound comprises graphite; and,
filling the heating pipe with a third heat transfer medium, wherein an interior surface of the heating pipe is adapted to receive thermal energy from the third heat transfer medium.
